(19) United States
(12) Patent Application Publication
(10) Pub. No.: US 2005/0027800 A1
(43) Pub. Date: Feb. 3, 2005

(54) Agenda-driven meetings

(75) Inventors: Thomas D. Erickson, Minneapolis, MN (US); Wendy A. Kellogg, Yorktown Heights, NY (US); Peter K. Malkin, Ardsley, NY (US); Tracee L. Wolf, Irvington, NY (US)

Correspondence Address: Eric W. Petraske, 68 Old Hawleyville Road, Bethel, CT, 06801, US

(73) Assignee: INTERNATIONAL BUSINESS MACHINES CORPORATION, Armonk, NY (US)

(21) Appl. No.: 10/628,217

(22) Filed: Jul. 28, 2003

(51) Int. Cl. G06F 15/16; H04Q 11/00; H04L 12/16

(52) U.S. Cl. 709/204; 370/260

(57) ABSTRACT

An Agenda-Driven Meeting (ADM) allows a distributed set of users to have an online, not necessarily synchronous meeting including an agenda which specifies both the topics or goals of the meeting's phases, as well as the interrelationship between the phases, including the order of execution. The system provides a graphical representation, which shows the status of each phase—including indicators of user participation—as well as the relationship between the phases. Input can include text comments; queries, potentially directed to one or more users; responses to these queries; task assignments, also potentially directed to one or more users; summaries of phases; and indicators of users interest in a given query or response. The ADM graphic representation reflects each of the elements including the particular phase to which a given element is related. The system allows a given user to replay a given ADM instance, even after the meeting has been completed. A service is also provided enabling a service organization to facilitate the use of Agenda-Driven Meetings by a customer organization.

### FIELD OF THE INVENTION

This invention relates to a graphical user interface for an online collaboration environment.

### BACKGROUND OF THE INVENTION

It often happens that a user finally manages to connect to an online meeting, but shows up after a significant amount of work has already been completed. The user needs to learn what's already been done; the current agenda item; and what's still to come.

Many technical solutions have been developed which address one or more of these questions.

NNTP or network news (see Ed Krol, The Whole Internet Catalog. O'Reilly and Associates, Inc. Sebastopol, Calif. 1992 for details) provides a venue in which users can asynchronously post messages and responses into administered news groups (i.e., predefined groups of messages which are meant to relate to specified topic, e.g., all articles in alt.sport.soccer should deal with soccer). Only loosely structured fomms of interaction are provided, e.g., query-and-respond. No other styles of interaction are supported. In particular, there is no way for users to define or participate in a particular style of interaction in which there is a predefined, interrelated sequence of phases, all newsgroups being independent from one another.

Internet Relay Chat (IRC) (see Ed Krol, The Whole Internet Catalog. O'Reilly and Associates, Inc. Sebastopol, Calif. 1992 for details) is similar to NNTP in that it allows users to post messages and responses to each other in predefined topic areas—called channels in IRC. The main difference with IRC is that the interactions are synchronous rather than asynchronous as in NNTP. Just as with NNTP, IRC does not enable users to define or participate in a particular style of interaction in which there is a predefined, interrelated sequence of phases, all channels being independent from one another.

Loom, a visualization tool for Usenet (NNTP) news groups, (for details, see Judith Donath et al. “Visualizing Conversation” published in the Journal of Computer Mediated Conversation. Volume 4, number 4, June 1999) provides a technique for displaying the emotional mood (e.g., hostile, happy) of an NNTP-based online community (e.g., a Usenet newsgroup) by analyzing the content of its interactions. Although this utility can analyze online interactions and provide a graphical representation of aspects of the interactions, it does not provide users with a sequenced, multiphase style of interaction, or an associated graphical user interface.

Babble (for details, see Thomas Erickson, et al. “Socially Translucent Systems: Social Proxies, Persistent Conversation, and the Design of ‘Babble.’” published in Human Factors in Computing Systems: The Proceedings of CHI '99. ACM Press, 1999.) provides dynamic indicators of the presence and activity of all operational users with respect to the available topics (i.e., discussion areas created by the users). These indicators are computed using the activities of the participants (e.g., connections, postings and topic switches). Although lightly structured styles of interaction are frequently adopted (e.g., interaction in the “—Commons Area—” is informal conversation, while interaction in the “Babble Problems” topic consists of serious question/answer dialogs), no way is provided to define a sequenced, multiphase style of interaction.

Online games, like chess and bridge (e.g., Chessmaster 6000 by Mindscape, Inc.) provide structured and enforced styles of interaction, but not ones that (1) can be defined by the users, the rules all being predefined; (2) that can have the rules changed by the users during a game (e.g., “A queen can leap from anywhere to anywhere”).

Coordinator and its patented method of structuring human communications (for details see: Flores et al. “Method and Apparatus for Structuring and Managing Human Communications By Explicitly Defining the Types of Communications Permitted Between Participants.” U.S. Pat. No. 5,208,748 May 4, 1993.) provides an electronic mail-based system that allows users to structure conversations and track tasks.

For example, a typical interaction begins with a “Request” message from person A to person B, requesting something from person B by a certain date. This e-mail note asks Person B to respond with a “Promise” message (promising to perform the action), with a “Decline” message (declining to perform the action), or with a “Counteroffer” message (offering to perform the action by a different date or to perform a different action). If B promises to do the action, then a typical conversation might continue with B eventually sending a “Report completion” message (indicating that the action has been performed) and A replying with a “Close” message (indicating that the action was performed satisfactorily).

The Oval implementation of Coordinator extends the base functionality by allowing end-users to modify interaction rules mid interaction (for details, see Malone et al. “Experiments with Oval: A Radically Tailorable Tool for Cooperative Work” via URL http://ccs.mit.edu/papers/CCSWP 181/index.html#4b).

Thus Coordinator, implemented with Oval allows users to define and maintain structured styles of online interaction. Users are still unable to handle interactions where messages are posted to a group of recipients, all of whom are not known a priori (e.g., as is the case in an brainstorming session where the participants include any and all contributing online users). Coordinator/Oval also does not provide a dynamic, graphical representation giving users with an overview and interface to a given meeting. In addition, no method or interface is provided allowing users to replay all or a section of a given meeting.

Work Flows allow users to specify sequences of steps, e.g., the steps required to fill out, submit and process a travel expense report, but do not provide users with a dynamic graphic representation of a multiphase online meeting, one providing users with an overview of all of the separate agenda item interactions (including indications of activity: who, what and how active).

Thus, there remains a need for a system and method providing online users with a dynamic graphic representation of the overview an agenda-driven, multiphase online meeting, one enabling users to replay previous activity.

Sametime Meeting, a product of IBM/Lotus allows users to create and interact with an instance of an online meeting, this interaction including the display of text, multimedia and compound documents, the environment providing indication of users' active connection to a given instance. Sametime Meeting does not, however, allow users to participate asynchronously, not does it provide a visualization of the active users that indicates their level activity relative to a given agenda item.

### SUMMARY OF THE INVENTION

The invention relates to a system for structuring an “agenda-driven meeting” (ADM) that allows a distributed work group, committee, or task force to have an online meeting to review the status of various ongoing projects.

A feature of the invention is an “agenda”, consisting of a list of items (e.g., goals) that defines a meeting phase, represented by a phase-shape, within which the given item is discussed.

An optional feature of the invention is that the meeting may be non-synchronous.

Another feature of the invention is that making user actions visible and public supports social awareness, which allows the group to enforce (or not) the interactional coherence of the group via social mechanisms such as peer pressure, imitation and etiquette.

Another feature of the invention is a user interface consisting of two interrelated parts: A phased social proxy representation that explicitly depicts the presence and activities of the participants in each phase of the conversation; and a multipaned phased representation of the conversation that depicts the conversation itself and the products of each of its phases.

Yet another feature of the invention is that four sorts of objects can be created in each phase:
Utterances: An utterance is a labeled, time-stamped textual comment, which, with other utterances, make up the conversation in a room.
Pointed Queries: Pointed Queries are questions which can be directed to one or more participants. A Pointed Query will call itself to the attention of a user, either directly (if the user is logged onto the system), or (after a predetermined time) will send itself as email to the user. The recipient of the emailed-pointed query can either click on a link to go to pointed query in the context of the online system, or can type an answer (including checking a “don't know”) box.
To Do's (which may optionally be assigned to particular people)
Glosses (which are typically summaries of the state of an agenda item)

Yet another feature of the invention is that:

All objects, including phases, can have various states:
Open/Locked: An object that is “open” can be entered, edited, or answered, as appropriate;
New Information/Seen (relative to a user): An object that has been created or contains new or changed content since a user last ‘looked at’ it is in the “New Information” state relative to that user.
Glitter/No Glitter (relative to a user): “Glitter” is a state that can be applied to an object by a user, to attract the attention of another user; it may have an optional note attached to it.

### BRIEF DESCRIPTION OF THE FIGURES

The foregoing and other objects, aspects, and advantages will be better understood from the following non limiting detailed description of preferred embodiments of the invention with reference to the drawings that include the following:

FIG. 1 shows an example of an agenda-driven meeting in process, which includes text and artifact display panes;

FIG. 2 shows an example of an alternative agenda-driven meeting;

FIG. 3 shows an example of a workflow-based agenda-driven meeting;

FIG. 4 shows an example of an agenda-driven meeting that includes a loop;

FIG. 5 depicts an overview of the network topology of an embodiment of the present invention;

FIG. 6 is a block diagram of an architecture of a server according to an embodiment of the present invention;

FIG. 7 is a flow diagram of the of a server program architecture according to an embodiment of the present invention;

FIG. 8 shows an example of a third-party service organization employing the invention.

### DETAILED DESCRIPTION OF THE INVENTION

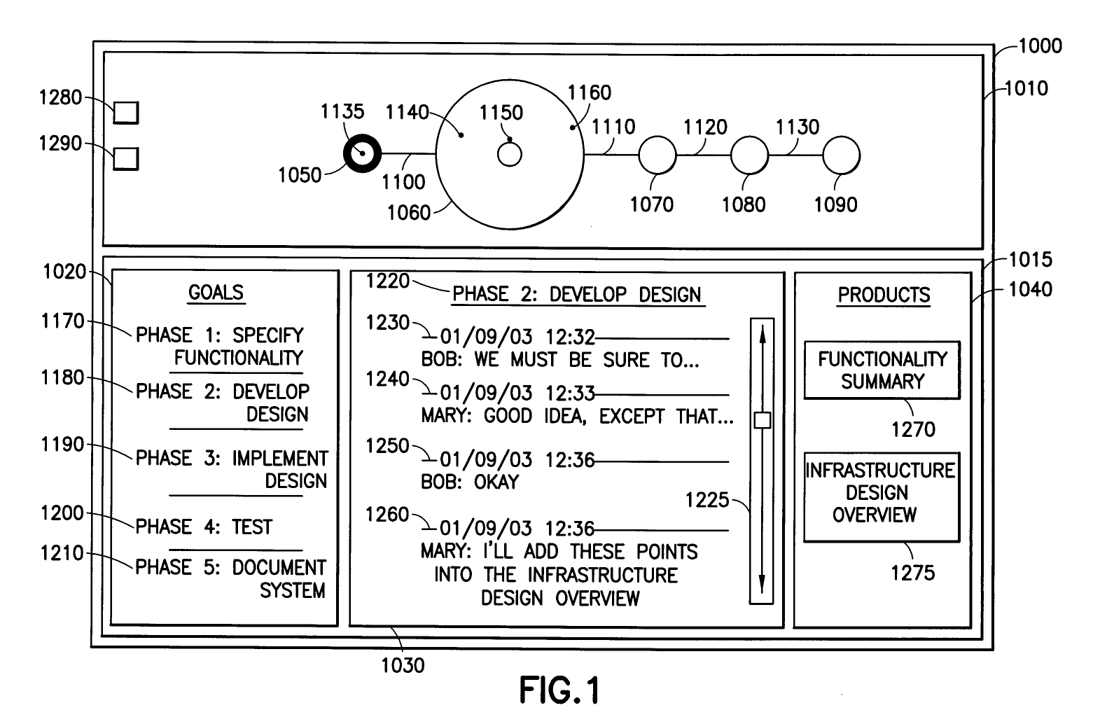

A detailed example of the preferred embodiment, is given, describing how the current invention is used in the process of supporting a design meeting. An example of this is depicted in FIG. 1. The user interface 1000 consists of two interrelated parts: A phased social proxy 1010 that explicitly depicts the presence and activities of the participants in each phase of the meeting; and a phased conversation representation 1015 that depicts the topics of the meeting's phases, the dialog of the current, and artifacts (e.g. Documents and drawings) related to or produced during the meeting.

The phased social proxy 1010 representing the meeting is a public representation—that is, all participants see the same representation, and all know that the others see the same representation.

The phased social proxy 1010 represents a given meeting by a series of simple phase-shapes 1050-1090 connected by lines 1100-1130,—each phase-shape corresponding to a particular phase of the meeting. By convention, the leftmost phase-shape 1050 is the first phase of the meeting, with the phase-shapes to the right 1060-1090 representing later phases respectively. One will appreciate that the line segments 1100-1130 could include arrow heads to indicate this sequencing explicitly. The phase-shape 1060 that depicts the “current” phase in which the group is involved expands to dominate the social proxy 1010; the other phase-shapes 1050 and 1070-1090, remain visible, but smaller. When the group progresses to the next phase (i.e., phase 3), this new phase becomes the “current” phase, its phase-shape (1070) expands, and the previous, completed phase-shape 1060 shrinks and becomes shaded. By differentiating the phase-shape of the current phase, participants are given a clear indication of the primary topic of interest. One will appreciate that other methods could be employed to distinguish the phase-shape of the current phase, including, but not limited to having it appear in a unique color or shape. One will also appreciate that the phased social proxy can be dynamically positioned so that the phase-shape representing the current phase is located centrally in the center of the 1010 space.

The meeting participants are represented as small dots 1135-1160, and are positioned in the phases of social proxy 1010 according to which phase they are currently involved in. Normally, most or all participants will be in the “current” conversation phase 1060; however, nothing prevents a given user from moving to a different phase, depicted by dot 1135 in phase-shape 1050.

When participants are active in the conversation (activity meaning that they ‘speak’ (e.g., contribute a comment), use a tool, or simply ‘listen’ (scroll the conversation phase-pane)), their dot (one of 1135-1160) moves into the center of the appropriate phase-space (one of 1050-1090); as they are idle, their dot drifts to the phase-space's periphery. This graphical depiction of the level of activity is just like that used in Babble (for details, see Thomas Erickson, et al. “Socially Translucent Systems: Social Proxies, Persistent Conversation, and the Design of ‘Babble.’” published in Human Factors in Computing Systems: The Proceedings of CHI '99. ACM Press, 1999).

Note that since the phased social proxy 1010 is public and, hence, seen equally by all participants, if a given user does move to a phase other than the current one, their movement will be visible to the entire group. This explicit indication provides a powerful “social affordance,” one that can press users to restrict their activities to the current phase so that their actions conform to that of the group. Alternatively, suppose a user does turn their attention to a previous phase, causing their dot 1135 to move to a noncurrent phase-shape 1050. Other participants seeing this might being to wonder why someone is still looking at this phase. Perhaps there remains resolved issues related to this phase. Perhaps the participant represented by dot 1135 came to the meeting late, and is reviewing the previous phase to catch up to the other participants.

The phased social proxy 1010 also includes representations of tools, shown here as small squares 1280 and 1290. Each of these shapes 1280, 1290 launches a different application that can aid users in the completion of the current phase. Such applications can include, but are not limited to, a timer, with which users can measure how long a given discussion takes; a voting application, with which users can make a final decision by casting votes for or against a given proposal or conclusion, or a random number generator, the products of which users can employ to make decisions (e.g., who will write up the summary of the given phase).

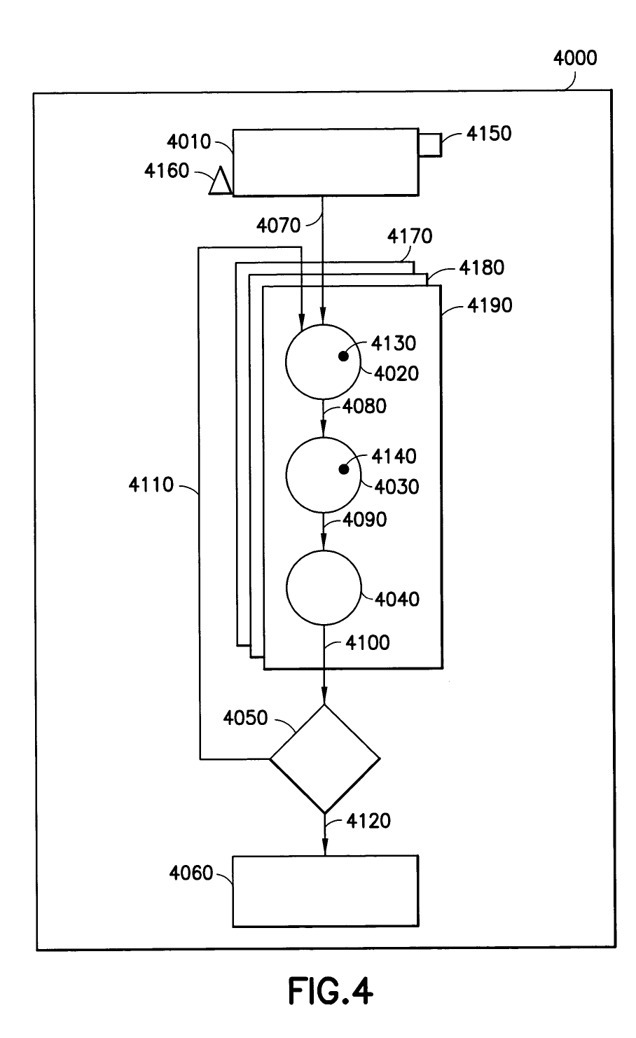

The current invention also includes a multipaned representation of the content of the meeting 1015, consisting of three panes:
The goal pane 1020 indicates the goal of each phase, 1170-1210. One will appreciate that these entries can include, but are not limited to titles (like those shown 1170-1210), short descriptions, and graphic images;
The conversation pane 1030 displays the comments 1230-1260 of the conversation phase that a particular participant is viewing. Note that if user 1 has selected phase 1, the pane 1030 they see will show the conversation from phase 1, while if user 2 has selected phase 2, they are shown the content of phase 2. Also note that for any given phase, the title 1120 of the conversation pane 1030 will match, indicating some or all of the data of the phase's corresponding goal pane entry. E.g., since phase 2 is the selected phase shown in FIG. 1, “Phase 2: Develop Design” 1180 from the goals pane 1020 is displayed as the title 1220 of the conversation pane 1030. Further, when one or more participants decide to leave the “current” phase, and move into another (previous or future phases), all participants in the current phase are shown a translucent image, or “shadow pane” of noncurrent dialog, slightly offset from the standard window 1030 (similar to the rectangles 4120, 4180, 4190 in FIG. 4). This is deliberately intended to be visible and even slightly distracting; since the out-of-phase participants know that their activities are visible and may distract the rest of the group (in the same way participants in a face-to-face meeting know that side conversations may disrupt a meeting), it encourages but does not mandate adherence to the group activity.
The products pane 1040 provides pointers to artifacts related to or produced during the meeting. These pointers can include, but are not limited to URLs of text, image and mixed type documents.

The contents of the both the goals 1020 and product 1040 panes remain the same regardless of which phase-shape a given user has selected.

Note that since all of the data in the current invention is maintained persistently, it can be viewed or heard by those who are not present.

A final feature of the conversation representation is that participants may attach annotations (similar to ‘sticky notes’) to a noncurrent conversation phase. These allow participants to add information, even though the primary content of a phase is frozen, or may not yet be created. These presence of such annotations is indicated by the thickening of relevant phase-shape's line width. Note the difference in the width of 1050 versus 1060-1090. One will appreciate that other graphic representations of the presence of such annotations exist including, but not limited to changing the color or line type of the relevant phase-shape.

The two components of the present invention 1010 and 1015, acting separately and in tandem, support the formation of group awareness, i.e., allow participants to know what others are doing, as well as supporting awareness of others' awareness. This group awareness is essential to the present invention in that it aims to support coherent group interaction (e.g., everyone attending to the same conversational phase) without rigidly mandating it. The following are the key aspects of social awareness that are supported:
In-phase versus out-of-phase (Who is where right now): Both components of the user interface 1010 and 1015 make it easy to see who (and how many) of those synchronously present are in the “current” phase (as defined by the group), versus other phases. In the social proxy 1010 this can be seen by the distribution of dots in the various components of the phase-spaces; in the conversation representation 1015 this can be seen by the presence of shadow panes
Active versus inactive (who is active right now): The social proxy 1010 allows participants to assess the degree of activity of the members of the group by noting the position of participants' dots relative to the center of each phase space

Another benefit of the present invention is that both the phased conversation representation 1015 and the phased social proxy 1010, by adding structure and richness to the conversation, permit it to be archived in novel forms. One such form is that of a persistent archive of the conversation with its contents organized according to conversation phases.

Because the activity of conversations participants is archived, the conversation can be replayed. Participants, or others interested in the conversation, can replay it at high speed to get a sense of the number of participants in each phase, the degree of coherence, and so on. To replay a previous completed phase, a player can select the corresponding phase-shape (e.g., 1050). As already described, this will result in the associated conversation being displayed in the conversation pane 1030. In the preferred embodiment, the conversation pane 1030 includes a scroll bar 1225, which can be used to scroll the presented conversation back and forth. Note that the data displayed in the Phased Social Proxy 1010, will track that displayed in all panes of the phased conversation representation 1015. Thus, the objects 1270 and 1275 displayed in products pane 1040, will only appear at the point in the meeting that they were created. Similarly, if object 1270 is deleted at some point in the meeting, its representation will vanish when this point is reached during replay.

One will appreciate that an archived, completed phase of a given meeting can be replayed by a given user either during a later phase of the meeting, or after the entire meeting has been finished. One will also appreciate that the current invention also covers other methods of replaying the conversation, including but not limited to providing users with a VCR-like set of controls (i.e., rewind: ““<<”; play: “>”; fast forward: “>>”; and stop: c).

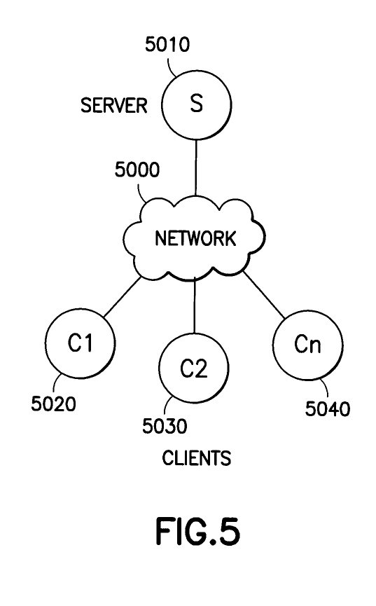

One will also appreciate that since a given meeting is provided by a persistent online service (as will be described in detail with reference to FIGS. 5-7), a given user can participate both synchronously, responding in real time to inputs made by other others; or asynchronously, interacting when they are able, adding data entered previously, or adding comments to phases that have not yet begun.

One with regular skill in the art will appreciate that during the use of an “instance” of the current invention, i.e., during a meeting held according to an embodiment of the invention, the configuration of the given instance could be modified (e.g., by a user with sufficient rights, say the meeting manager). These modifications might include, but are not limited to the addition or deletion of one or more phases, as well as the reordering of one or more phases.

One with regular skill in the art will also appreciate that a given phase's state (e.g., completed) can be set either by a single user (e.g., one with sufficient rights or in a particular role, like the moderator of the particular phase); or by a set of users, including, but not limited to a vote by all users currently active in the given phase.

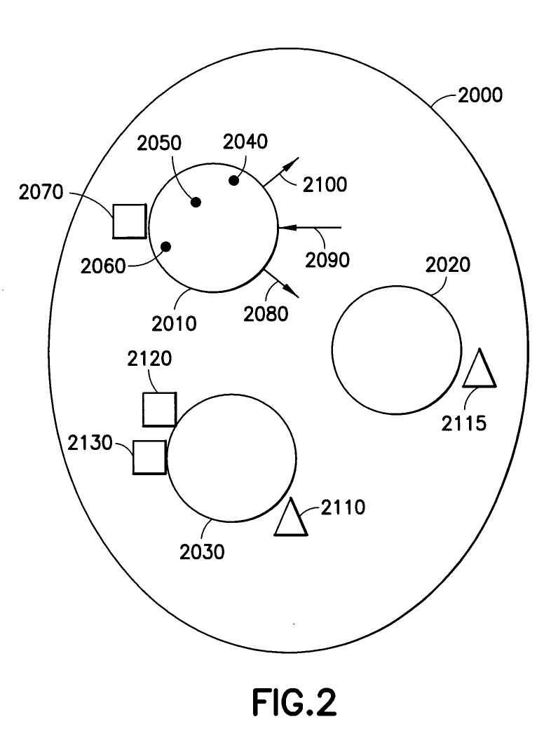

The current invention also provides three extensions to the graphical user interface and multiphase online collaboration method (discussed in detail with reference to FIGS. 2, 3, and 4).

FIG. 2 depicts an alternative version of a phased social proxy 2000. Just as in 1000, this version uses phase-shapes 2010-2030 to represent the phases of a given meeting —the meeting represented here only having three phases, one phase-shape 2030 indicating that the phase associated with it has been completed. Here too, active participants are represented with dots 2040-2060, a given dot's location indicating in which phase the associated user is currently participating, with the dot's distance from the center of the phase-shape indicating the associated user's level of activity. The phase-shapes 2010-2030 in FIG. 2 are not connected to each other in any way, as are those 1050-1090 in 1000. This indicates that there is no preset sequence to the meeting's phases.

Phased social proxy 2000 also contains 3 new types of icons: arrows 2080-2100; squares 2070, 2120 and 2130; and triangles, 2110-2115.
Pointed Queries—represented by standalone arrows 2080-2100 pointing either towards or away from the phase-shape to which they are associated—are questions which can be directed to one or more participants. An arrow pointing away from a given phase-shape, e.g., 2080 or 2100, represents a pending query, while an arrow 2090 pointing towards a given phase-shape represents a query that has already been answered. A Pointed Query will call itself to the attention of a user, either directly (if the user is logged onto the system), or (after a predetermined time) will send itself as email to the user. The recipient of the emailed-pointed query can either click on an arrowhead to go to pointed query in the context of the online system, or can type an answer (including checking a “don't know”) box (not shown). The answer to a given completed pointed query (e.g., 2090) can be accessed by selecting its arrow. Methods by which a given response can be seen include, but are not limited to having the response's data displayed in a pop-up window, or sent in an email.
To Do's—represented by squares 2070, 2120 and 2130 located next to the phase shape to which they are associated—are indicators of tasks that still need to be completed. To Do's may optionally be assigned to particular people. Such task assignments can include, but are not limited to the gathering of additional related information, e.g., a search for prior art after a patent disclosure meeting, or contacting another group of users to see the if they would like to join the current project.
Glosses—represented by triangles 2110-2115 are typically summaries of the state a given phase, a given gloss being associated with the phase-shape to which it is nearest. Note that there can be glosses for both active phase, like that represented by phase-shape 2020, as well as ones that have been completed, like that represented by phase-shape 2030. One will appreciate that a gloss can be used to indicate both intermediate (e.g., “Two conflicting solutions are being discussed; everyone seems dissatisfied”) and final (e.g., “One of the two solutions was finally chosen, but a large number of group members are not pleased”) comments regarding a given phase.

In addition a user can mark an object (including a room) with Glitter (relative to a user). “Glitter” is a state that can be applied to an object by a user to attract the attention of another user; it may have an optional note attached to it.

One will also appreciate that participants can take on one of several roles, each of which has permissions associated with it:

| | | | Meeting | Purpose of |
|---|---|---|---|---|
| Role | Conversation | Email | Creation | Role |
| Chair | rwx | receive | rwx | Run meeting |
| | (read/write/ | | | |
| | execute) | | | |
| Participant | rwx | receive | | Normal |
| | | | | participant |
| Lagger/Lurker | r | — | — | Non- |
| | | | | participant, or |
| | | | | someone who |
| | | | | will be out of |
| | | | | email contact |
| | | | | for the duration |
| | | | | of the meeting |

Modes of Use: As noted above, this is intended to allow groups to have online, not-necessarily synchronous status meetings. At one extreme one could imagine that only the meeting's chairs actually enter the online space, conducting the entire meeting by sending out pointed queries, and using the responses to generate Glosses and To Dos. At the other extreme, we could imagine a fully synchronous meeting, in which either everyone moves synchronously from item to item, or in which participants spread out over the agenda, gravitating to the most relevant topics, and filling in their statuses. In this situation, pointed queries could be used to attract the attention of a particular participant when their input is required.

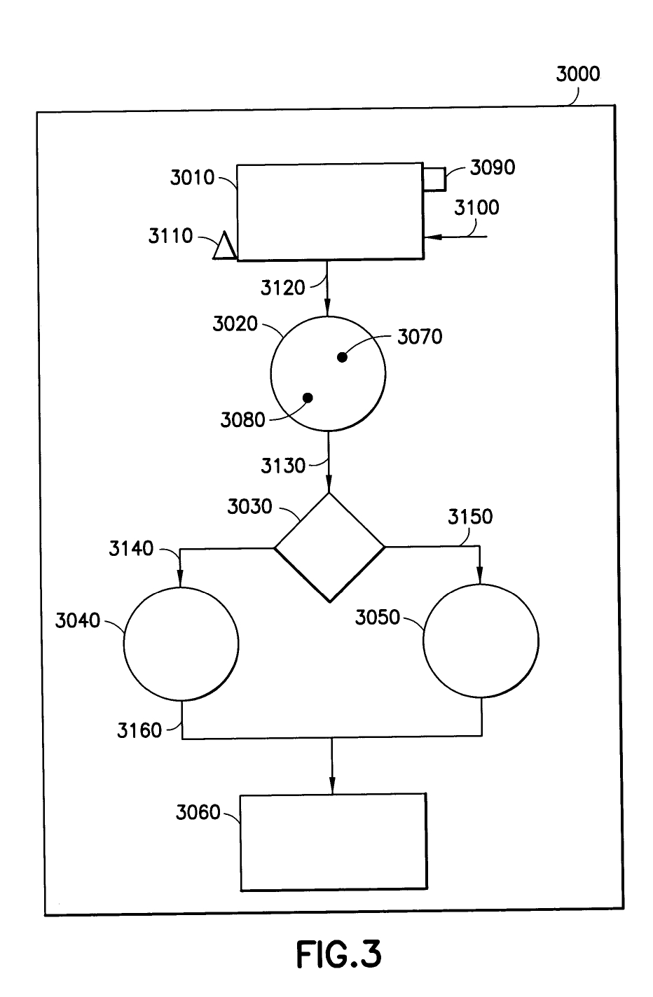

FIG. 3 depicts yet another version of the phased social proxy 3000, which has 2 new aspects. The first is that its phase-shapes 3010-3060 are not all the same geometric shapes. There are two rectangles 3010 and 3060, three circles 3020, 3040 and 3050; and one diamond 3030. These different shapes can be used to indicate types of phase tasks. So for example:
Rectangular phase-shapes, like 3010 and 3060, could indicate introductory and summary phases;
Circular phase-shapes, like 3020, 3040 and 3050, indicating design and development; and
Diamond shapes, like 3030, indicating a decision point, e.g., “Will we use a procedural or object-oriented programming language?”).

The other new aspect of the phase social proxy 3000 is that in addition to connectors 3120-3160 between the phase-shapes 3010-3160, like those 1100-1130 in 1000, one of 3000's phase shapes 3030 has two connectors coming from it, 3140 and 3150. This is a graphical representation of how the choice made in the phase corresponding to phase-shape 3030 determines which phase is executed next, that corresponding to 3040, or 3050. This ability to represent conditional branching enables users to employ the current invention to conduct online meeting based on a given business procedure, like a workflow. Workflows can include but are not limited to, purchasing or travel expense accounting. Thus, 3000 might be an overview of the execution of an travel expense account, with phase-step 3010 being where the employee enters their expenses; 3020 where the employee and their boss discuss a particular expense item; 3030 where the boss and the account department determine which project will pay for the given trip; 3040 and 3050 corresponding to the two possible projects from which the fund are transferred; and 3060 being where the overall transaction summary reports are created and sent to the related parties.

The current invention also anticipates how a phase social proxy could be automatically generated from a existing workflow specification.

FIG. 4 depicts a final version of the phased social proxy 4000, which includes a graphic representation of a loop. As in 3000, the diamond-shaped phase-shape 4050, represents a choice point. The difference in 4000 is that one of the connectors 4110 connects back to a previously visited phase-shape 4020. This represents the case of a loop structure, with phase-shapes 4020 through 4040 representing the loop steps to execute respectively each time through the loop, and with phase-shape 4050 representing the loop termination condition. Whenever the discussion reaches phase-shape 4050, the users must make a choice, and, depending on their answer, activity continues at either 4020 again, or at 4060.

In addition to providing a dynamically updated representation of the current state of the online meeting and the activity of its users, the current invention also provides access to a graphical user interface to previously executed passes through the loop. Each of 4170, 4180 and 4190 (each a phase-shape-loop) represent passes through the loop, 4190—the bottom-right-most one representing the most recent. If a user wants to see the loop's phase-shapes—including glosses, pointed queries and To Do's—as they looked during previous passes through the loop, they can select the corresponding phase-shape-loop, For example, 4000 could represent the online discourse regarding the iterative design of a prototype, the phase-shapes representing the following topics:
4010, determination of the prototype's goals and metrics;
4020, development or update of the prototype's design;
4030, prototype implementation;
4040, user-testing of the prototype's latest implementation;
4050, evaluation of whether the prototype's goal's have been met; and
4060, Overall usage and installation documentation.

If a given user wanted to see the previous pass through the design-implement-test loop, they could select the 4180 phase-shape-loop. This would bring 4180 to the foreground, showing 4020-4040 as they looked at the beginning of this loop's execution. By scrolling through the loop's execution, e.g., using the 1225 scroll bar, this activity that took place during this loop's execution can be reviewed.

One with regular skill in the art will appreciate that graphical representations of additional meeting-related products are also anticipated by the current invention. These include, but are not limited to arrow-shaped boxes positioned adjacent to a phased social proxy, which represents agenda items proposed for a subsequent meeting.

The preferred implementation of the current invention is as a web-based (HTTP-based) network application, as will be described in detail with reference to FIGS. 5,6 and 7.

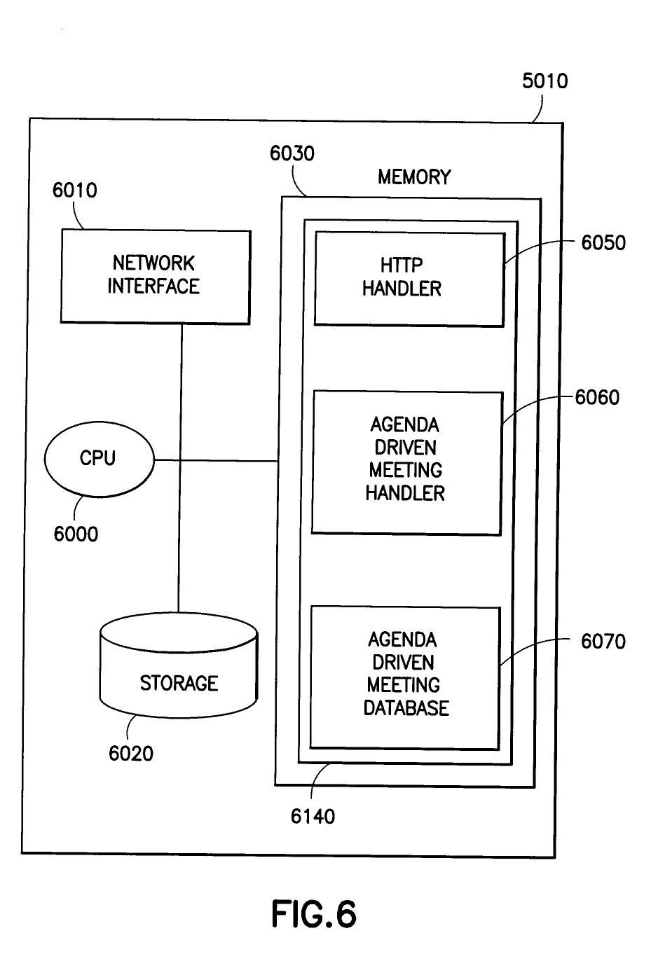

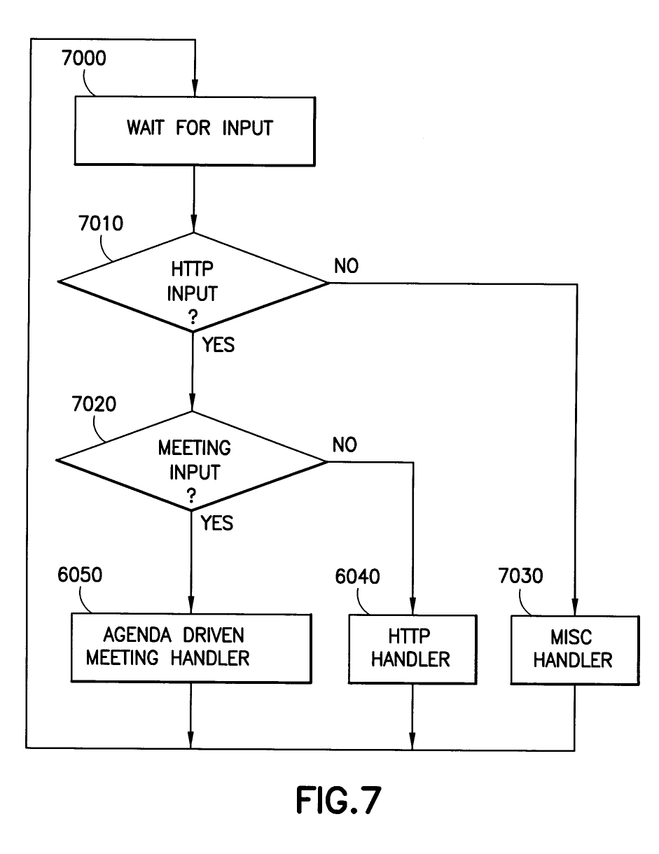

FIG. 5 depicts an example of an overall logical network topology within which preferred embodiment of the current invention runs. As shown, a server 5010 (which will be described in detail with reference to FIGS. 6 and 7)), and clients 5020-5040 are all connected to the network 5000, through which they communicate. Although only three clients 5020-5040 are shown in FIG. 5, the present invention is applicable to any number of clients.

The server 5010 can be any computing node able to act as an HTTP server. This includes, but is not limited to, the products sold by IBM under the trademarks ThinkPad or PowerPC, running the operating system and server application suite sold by Microsoft under the trademark Windows NT.

Examples of the network 5000 include, but are not limited to, the Internet and private intranets.

The each client 5020-5040 can include any network node able to act as an HTTP client.

Examples include, but are not limited to, an IBM ThinkPad running Windows 95 and a web browser such as Microsoft's Internet Explorer, or Apple's Power Macintosh running MacOS 8.5.6 and a web browser such as Netscape's Navigator. Clients also include network-connectable mobile (i.e. portable) devices such as that sold under the trademark WorkPad by IBM, as well as smart cellular telephones (i.e., devices which can act as a cellular telephone as well as run network applications, like web browsers), like that sold under the trademark Nokia 9000i by Nokia.

In the preferred implementation, the client application is an applet retrieved from the server 5010, and run via the client's HTTP client (web browser). Also, in the preferred implementation, this applet, in addition to handling data display and user interactions (e.g., data entry and mouse events), also constantly polls the server 5010 for updated data, this data being the latest version available for the meeting instance currently being viewed. Those with regular skill in the art will appreciate that there are other methods of retrieving such data, including, but not limited to having the server push updates, whenever available down to the client, the client listening on a port known to the server (for details, see Douglas Corner, Internetworking with TCP/IP, Vol. 1 Principles, Protocols and Architecture. Prentice Hall, Englewood Cliffs, N.J., 1991.).

FIG. 6 depicts a more detailed example of the server 5010, which hosts the online Agenda-Driven Meeting environment. The server 5010 preferably includes a CPU 6000, a network interface 6010, a storage device 6020 such as a disk or DASD, and memory 6030, such as RAM. According to the present invention, the Agenda-Driven Meeting logic 6140 (as will be discussed in more detail with reference to FIG. 7), is preferably embodied as computer executable code that is loaded from remote (e.g., over the network via the network interface 6010) or local permanent optical (CD-ROM) or magnetic storage such as disk, or DASD 6020 into memory 6030 for execution by CPU 6000. The memory 6030 preferably includes an HTTP handler 6050, an Agenda-Driven Meeting Handler 6060 (discussed in detail with reference to FIG. 7), and an Agenda-Driven Meeting database 6070. The HTTP handler 6050 can be any standard HTTP server, such as the product sold by the IBM under the trademark WebSphere.

The Agenda-Driven Meeting database 6070 can be any application providing access and persistent management of data, such as that sold by IBM under the trademark DB/2. Those with regular skill in the art will also appreciate that the Agenda-Driven Meeting database 6070 could be run on another remote network connected node and accessed via the network 5000.

FIG. 7 depicts an example of the Agenda-Driven Meeting logic 6140. As shown, the server 5010 waits for input in 7000. The input is checked in step 7010, and unless it involves HTTP input, control is passed to a miscellaneous handler 7030, which performs conventional functions. One with regular skill in the art will appreciate that the check done in step 7010, could be accomplished by verifying that the TCP/IP port by which the server was contacted corresponds to that used to handle HTTP protocol, typically 80. If the input is HTTP-related, then the input is further checked in step 7020 to determine if it is Agenda-Driven Meeting related. If not, control is passed to the HTTP Handler 6050. Otherwise control is passed to the Agenda-Driven Meeting Handler 6060. One with regular skill in the art will appreciate that the check performed in step 7020 consists of that parsing the HTTP request and checking whether it contains one of a finite set of commands unique to the Agenda-Driven Meeting Handler 6060. Following the completion of any of the handlers, i.e., steps 6050, 6060 or 7030, the flow continues at step 7000, where the server 5010 waits for input.

The Agenda-Driven Meeting Handler 6060 shown in FIGS. 6 and 7, is the interface that responds to all requests concerning agenda-driven meeting, thus controlling the creation and use of such online collaboration environments. As discussed with reference to FIGS. 1,2,3, and 4, Agenda-Driven Meeting requests include the following:
Creating a new instance;
Connecting to a existing active instance (active or completed);
Entering data into a active instance;
Retrieving data from an (active or completed) instance;

For each request that arrives, the Agenda-Driven Meeting Handler 6060 determines its type and applicable agenda-driven meeting instance, processes the given event, updates the given meeting's data in the database 6070, updates the graphical representation for the given meeting instance—also stored in the database 6070; and then sends the updated graphical representation out to all active users of the given meeting instance.

The Agenda-Driven Meeting Handler processes different requests slightly differently:
If the given request is to one to create a new agenda-driven meeting instance, then:
   An entry for the new meeting is added to the database;
   The number of phases and their interrelationship, if any, is added to the entry
   A phased social proxy is created for the instance and stored in the database entry, this graphic including a representation of the creator and their level of activity;
   The social proxy is added to the database entry;
   All data for the instance is communicated back to the creator's client application.
If the given request is one for a user to connect to any existing meeting instance, then:
   The user's id is added in as one of the active users in the requested meeting instance's database entry;
   The instance's phased social proxy is updated to reflect the new user's becoming active, this new proxy being stored in the instance's database entry;
   The meeting instance's updated data, including its phased social proxy, is sent to all active users;
If the given request is one from a user asking to retrieve data from an existing meeting instance, then:
   The particular piece of data being requested is identified;
   The requester's access rights are checked to verify that they view the requested data, the server returning a warning to the requesting user if not;
   The given meeting instance's phased social proxy is updated, to reflect the retrieval of the given piece of data (e.g., the given user's dot moves closer to center of their current phase-shape to reflect their level of activity), the modified phased social proxy added to the instance's database entry;
   The fact that the given user requested the given piece of data is written into the meeting instance's database entry;
   The meeting instance's updated data, including its phased social proxy, is sent to all active users;
   The requested data is sent to the requesting user.
If the given request is one from a user asking to enter data into an existing meeting instance, then:
   The particular piece of data the requester is asking to add (e.g., a comment, To Do, or Pointed Query) is identified;
   The requester's access rights are checked to verify that they are authorized to add the given piece of data, the server returning a warning to the requesting user if not;
   The data is added into the given meeting instance's database entry;
   The given meeting instance's phased social proxy is updated to reflect the addition of the given piece of data, the modified phased social proxy added to the instance's database entry;
   The fact that the given user added the given piece of data is written into the meeting instance's database entry;
   The meeting instance's updated data, including its phased social proxy, is sent to all active users;
If the given request is one from a user asking to retrieve an archived meeting instance, then:
   The particular meeting instance the requester wants is identified;
   The requester's access rights are checked to verify that they are authorized to view the given instance, the server returning a warning to the requesting user if not;
   The server creating a new read-only version meeting instance, using the data retrieved from the requested meeting instance;
   The new meeting instance's updated data, including its phased social proxy, is sent to all active users;
If the given request is one from a user asking to create a template from the current meeting instance, then:
   The user is prompted for a name for the new meeting template; and then
   A new template is stored in the database, using the given name, the content of the template, being that of the current meeting's agenda (i.e., specification of the phases, their types and the interrelationship between them.

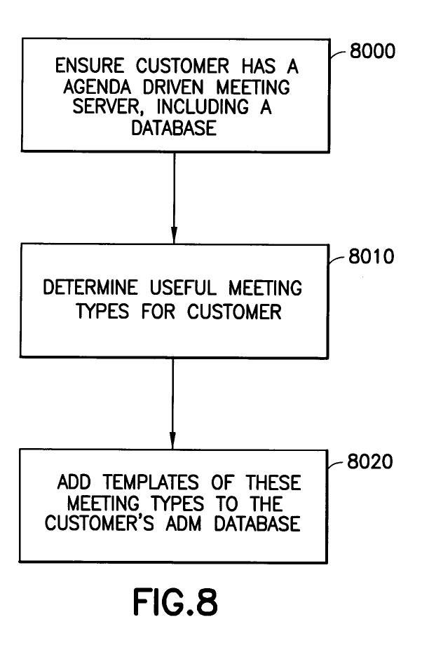

The present invention also provides a method by which a third party service organization can make the agenda-driven meeting facility available for use by members of a customer organization. This process is depicted in FIG. 8. As shown, the first step 8000 is to ensure that the customer has the required Agenda-Driven Meeting server, such as that depicted and described in detail with reference to FIG. 6, which includes the HTTP Hander 6050, the Agenda Driven Meeting Handler 6060, and the Agenda Driven Meeting Database 6070. Next, in step 8010, the service organization determines types of meetings that are useful for the customer. Methods by which this determination could be accomplished include reviewing previous meeting types, e.g., by reviewing the customer organization's past calendars; or by interviewing employees and asking them their opinion. One with regular skill in the art will appreciate that interviewers could provide examples of types of meetings, and ask which of samples seemed most applicable. One with regular skill in the art will also appreciate that templates could either be provided one-by-one or in sets, members of which would be related in some way. Finally, in step 8020, the service organization would add these templates to the customer's Agenda Driven Meeting database 6070. With this service, the customer would have a specially filtered set of templates available to them when they began using the Agenda Driven Meeting facility, the set including needed meeting types, while not having unrelated meeting types that would only serve to distract users. One with regular skill in the art will further appreciate that the service organization could also provide updates and or additions to the templates, also, potentially specialized for the particular customer. These upgrades and additions could even be supplied on a periodic basis, e.g., yearly.

Another benefit of the present invention is that both the Phase Conversation Representation and the Phased Social Proxy, by adding structure and richness to the conversation, permit it to be archived in novel forms:
The archiving of the content for each phase: A result of the use of the present invention for carrying out semi-structured conversations is a persistent archive of the conversation with its contents organized according to conversation phases.
The archiving of conversational activity: Because the activity of conversations participants is archived, the conversation can be replayed. Participants, or others interested in the conversation, can replay it at high speed to get a sense of the number of participants in each phase, the degree of coherence, and so on.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

Having described embodiments for peer-to-peer interaction and more particularly to a method for flexibly relating information, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. An article of manufacture in computer readable form comprising computer readable program code means embodied therein for performing in a computer system a method for providing an online collaborative environment for at least one user, said computer readable program code means for causing a computer to effect the method comprising the steps of:
a) creating an instance of an online meeting, the instance including phases, and an agenda of the meeting's phases;
b) receiving input from at least one user;
c) depicting said input in a graphical representation including a set of objects; and
d) forwarding said representation to said at least one user.

2. An article according to claim 1, further comprising means for:
Determining if all meeting phases have been completed;
If all meeting phases have been completed, terminating the meeting instance;
If all meeting phases have not been completed, repeating steps a)-d) until all phases specified in said agenda are completed.

3. An article according to claim 2, wherein the step of depicting includes an indication of said at least one user's activity, based on a comparison of said activity with a criterion.

4. An article according to claim 1, wherein said user input is selected from the group comprising a query, a response, a text comment, and a task specification; and wherein said representation includes a handle to said input, which can later be used to retrieve said input.

5. An article according to claim 1, including means for providing a dynamic determination of the next active phase based on results or analysis of participation of previous phase(s).

6. An article according to claim 1, wherein said at least one user is assigned a role and the type of input and associated phase in which input can be given is restricted by the role.

7. An article according to claim 1, wherein the active phase is emphasized in a visual representation of the meeting.

8. An article according to claim 1, of providing a transition from one phase to an earlier phase in said agenda; and
providing at least one of a graphic representation of one or more interactions of a given loop; and
means for enabling said at least one user to review an earlier iteration of said loop.

9. An article according to claim 1, wherein said representation includes both graphic and text section and where the content of said text section is automatically adjusted to match user selection of the point of focus in the graphic section.

10. An article according to claim 9, including showing in said graphic section said at least one user's visiting a previous or future phase.

11. An article according to claim 9, including means for setting status of objects in said graphic representation to one or more of:
Open/Locked;
New Information/Seen;
Glitter/No Glitter.

12. A system for providing an instance of an online collaborative meeting for at least one user, the system comprising:
a) a database that provides persistent access to data;
b) a server that enables the creation of an instance of an agenda driven meeting and that receives all meeting inputs, logs said inputs in said database, updates a representation of said instance, and forwards the representation to said at least one user; and
c) at least one client enabling said at least one user to enter and input and receive said representation.

13. A system according to claim 12, wherein the server is a web-portal and said receiving and forwarding is performed using the HTTP protocol.

14. A system according to claim 13, further comprising creating an archive version of the completed meeting instance.

15. A system according to claim 12, further comprising means for:
Said at least one user retrieving said meeting archive; and
Said at least one user replaying said meeting instance, said replay including at least one of the instances' phases.

16. A method for providing in a computer system an online collaborative environment for at least one user, comprising the steps of:
a) creating an instance of an online meeting, the instance including phases, and an agenda of the meeting's phases;
b) receiving input from at least one user;
c) depicting said input in a graphical representation including a set of objects; and
d) forwarding said representation to said at least one user.

17. A method according to claim 16, further comprising steps of:
Determining if all meeting phases have been completed;
If all meeting phases have been completed, terminating the meeting instance;
If all meeting phases have not been completed, repeating steps a)-d) until all phases specified in said agenda are completed.

18. A method according to claim 17, wherein the step of depicting includes an indication of said at least one user's activity, based on a comparison of said activity with a criterion.

19. A method according to claim 16, wherein said user input is selected from the group comprising a query, a response, and a task specification; and wherein said representation includes a handle to this input, which can later be used to retrieve said input.

20. A method according to claim 16, of providing a dynamic determination of the next active phase based on results or analysis of participation of previous phase(s).

21. A method according to claim 16, wherein said at least one user is assigned a role and the type of input and associated phase in which input can be given is restricted by the role.

22. A method according to claim 16, wherein the active phase is emphasized in a visual representation of the meeting.

23. A method according to claim 16, of providing a transition from one phase to an earlier phase in said agenda; and
providing at least one of a graphic representation of one or more interactions of a given loop; and
means for enabling said at least one user to review an earlier iteration of said loop.

24. A method according to claim 16, wherein said representation includes both graphic and text section and where the content of said text section is automatically adjusted to match user selection of the point of focus in the graphic section.

25. A method according to claim 24, including showing in said graphic section said at least one user's visiting a previous or future phase.

26. A method according to claim 24, including means for setting status of objects in said graphic representation to one or more of:
Open/Locked;
New Information/Seen;
Glitter/No Glitter.

27. A method enabling a service organization to give a customer organization the ability to use Agenda-Driven Meetings, the method consisting of the following steps:
Ensuring the customer organization has the hardware and software required to host the Agenda-Driven Meeting service, including a database;
Determining meeting types that are useful for said customer organization;
Adding templates for said meeting types to said database.

28. A system according to claim 27, further consisting of the service organization providing upgrades, or new templates useful to said customer.

29. A method according to claim 28, wherein said upgrades and additions are provided by said service organization to said customer organization periodically.

30. An article according to claim 1, including means for enabling a given user to participate in a given instance of an online meeting either synchronously or asynchronously.
